(19) United States
(12) Patent Application Publication
(10) Pub. No.: US 2011/0264583 A1
(43) Pub. Date: Oct. 27, 2011

(54) INTER-NETWORK INVOICING PAYMENT METHOD AND SYSTEM

(76) Inventors: David Cooper, Los Gatos, CA (US); Sanjeev Dheer, New York, NY (US); Krishna Bhagavatula, Fremont, CA (US); Catherine Palmieri, New York, NY (US); John Lovelett, New York, NY (US)

(21) Appl. No.: 13/092,908

(22) Filed: Apr. 22, 2011

Related U.S. Application Data
(60) Provisional application No. 61/327,053, filed on Apr. 22, 2010.

(51) Int. Cl. G06Q 20/00; G06Q 40/00

(52) U.S. Cl. 705/40

(57) ABSTRACT

An inter-bank email and mobile invoicing network is disclosed. Embodiments disclosed herein include an inter-bank email and mobile invoicing network that enables customers of banks or independent portals to send invoices to an email address or mobile phone number. The invoice can be received by the recipient within their bank's online or mobile banking site, in the case of banks that belong to a network that is managed by the proprietors of a financial management system and payment hub as disclosed herein. These banks will be referred to as “network banks” herein. The inter-bank invoicing network also refers to a common provider or connected providers of an invoicing and payment service that is linked to banks and to independent service providers.

### RELATED APPLICATIONS

This application claims the benefit of U.S. Provisional Patent Application No. 61/327,053, filed Apr. 22, 2010. This application is also related to the following U.S. patent application Ser. Nos. 11/348,535, filed Feb. 6, 2006; 11/879,818, filed Jul. 19, 2007; 12/109,309, filed Apr. 24, 2008; 12/109,318, filed Apr. 24, 2008; 12/543,497, filed Aug. 18, 2009; 12/543,501, filed Aug. 18, 2009; and 12/968,189, filed on Dec. 14, 2010. All of the foregoing applications are incorporated in their entirety herein by reference.

### BACKGROUND

Presently, there are various facilities available for making payments from one person or entity to another person or entity online using the Internet. The assignee of the current application has filed multiple patent applications related to this capability. For example, the current assignee has disclosed capabilities including online invoicing and inter-bank party-to-party (P2P) payment networks. These disclosures include online invoicing, inter-bank email, and mobile P2P payments networks. What has not been achievable until now is an online inter-bank invoicing network that allows entities to submit/receive invoices, and submit/receive payments easily within the online and mobile banking sites of the banks belonging to a network that is operated by a financial management system (FMS), where the FMS provides one hub that is independent of financial institutions so that invoicing and payment transactions can be completed even if the bank of either the sender or the recipient (or both) does not belong to the network.

### BRIEF DESCRIPTION OF THE DRAWINGS

FIG. 1 is a block diagram of an internetworking payment system 200 according to an embodiment.

FIG. 2 is a flow diagram illustrating a process or payment method according to an embodiment.

FIG. 3 is a flow diagram illustrating a process or payment method according to an embodiment.

FIGS. 4A and 4B show screen shots of a user sending an invoice within online banking.

FIGS. 5A and 5B show screen shots of a user paying an invoice within the PopMoney hub.

FIG. 6 is a diagram illustrating the manner in which small business and retail are internetworked.

FIG. 7 is a diagram illustrating how PoPnet couples various entities as previously described and also couples social networking sites a nodes.

FIGS. 8-23 are screen shots illustrating how social networking sites are integrates as nodes in the network.

### DETAILED DESCRIPTION

Embodiments disclosed herein include an internetworking invoicing and payment method and system enabling users to send invoices to payees via a payment hub. The payment hub also functions as an electronic bill presentation and payment (EBBP) network. The payment hub internetworks many types of nodes that include banks, other financial institutions, peer-to-peer (P2P) financial institution networks, P2P payment networks social networking sites, and general purpose reloadable card networks (pre-paid card, and transit cards, and college cards, and payroll cards). Users include individuals, small and large businesses, organizations, and entities authorized to act on behalf of account holders. Payees can also include individuals, small and large businesses, organizations, and entities authorized to act on behalf of account holders.

The payment hub as described below facilitates and executes transaction on behalf of users, such that the transaction can take place between various internetworked nodes transparently to the users. As further described, the payment hub stores tokens received from various nodes that both identify the user, provide user data, and associate the user data with the node. The payment hub uses the token data to act as the intermediary of the transaction between two nodes on behalf of a user.

The transaction conducted in this way are particularly secure. As explained further below, within the payment network defined by the hub, the user does not need to enter any confidential information. For example, the user can conduct the transaction on his or her own banking web site (or other node web site), which has already populated the required information. In addition, the user's node web site typically takes care of verification and authentication for the transaction automatically.

Various aspects of the back-end system as used herein are generally disclosed in previous patent applications of the same assignee as this patent application (including, but not limited to, the patent applications listed above).

The assignee of the present application has disclosed, claimed and practiced a network under the name of Popmoney™. For ease of illustration, Popmoney™ will be used herein as an example of an inter-network invoicing and payment method and system. This inter-network concept allows for the independent PoPNet™ hub (accessible at Popmoney.com™) at which a recipient of payments, and a sender of invoices can take advantage of all of Popmoney™ features even if recipient's bank does not belong to the network. The network is also extendible to include independent direct-to-consumer services.

While this network is described at times herein in the context of being accessed from within the online or mobile site of the bank, such a service could also be provisioned from a mobile phone by a telecom provider, especially using smart phones like the Iphone™, or Android™, or Blackberry™. In this context, a user can download the application and then send an invoice and receive payment. The user can link it to their bank account and the payments can be made by the recipient from their bank account or debit/credit/pre-paid account.

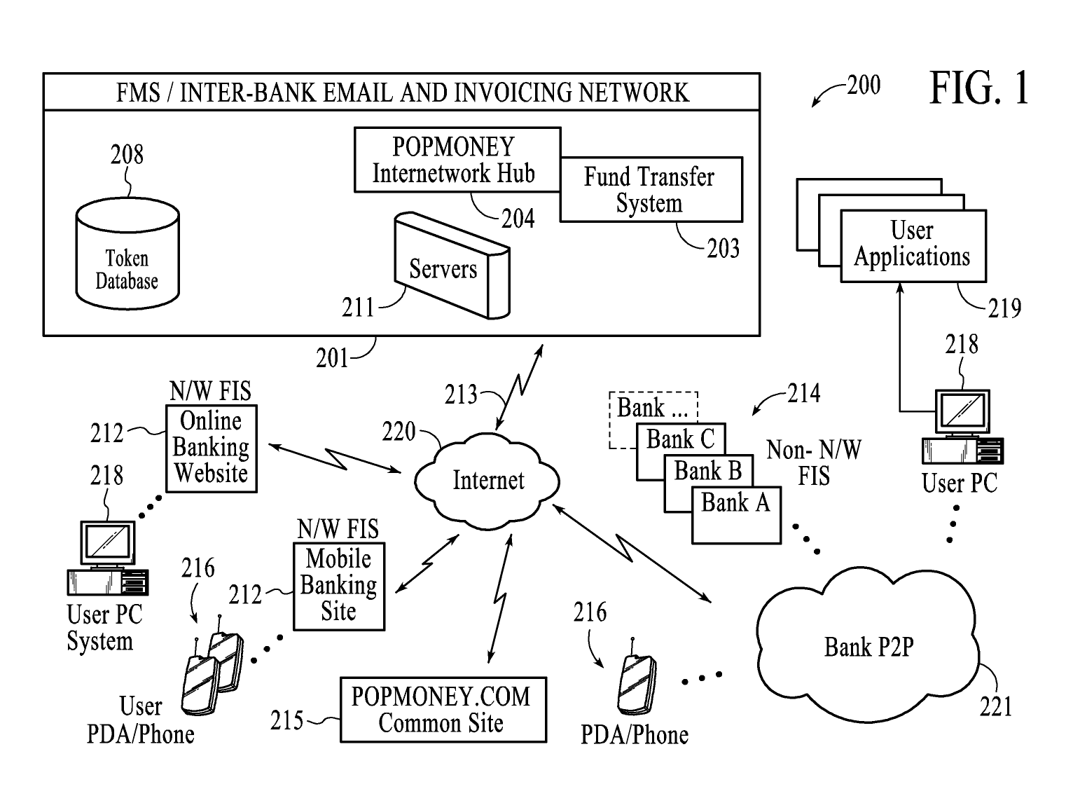

FIG. 1 is a block diagram of an internetworking payment system 200 according to an embodiment. System 200 includes a financial management system (FMS)/inter-bank email and invoicing network 201 coupled to a network 220, such as the Internet. Network 201 includes a funds transfer system 203, databases 208, servers 211, and an internetwork hub 204. POPmoney® internetwork hub 204 is one proprietary name for an electronic payment service as described herein, but that is not intended to be limiting. The POPnet® Internetworking hub is connected to but discrete from the POPmoney.com® common web site 215. In various embodiments, aspects of the financial management system, such as the funds transfer module system 203, are provided by CashEdge®, Inc. of New York, N.Y. The funds transfer system is the subject of U.S. Pat. Nos. 7,383,223, 7,505,937, 7,321,875, and 7,321,874 assigned to CashEdge®, Inc. All of the foregoing U.S. Patents are incorporated by reference herein.

The servers 211 include various servers coupled to other entities via the Internet. As described herein, various entities are said to be network entities, such as network financial institutions (NW FIs) 212. Other entities are not currently in the network, such as non-network FIs 214. Entities that can be part of the network include many types of entities other than FIs. For example Bank P2P networks and other networks 221 include P2P networks, social networking networks, general purpose reloadable card networks, but embodiments are not so limited. Networks 221 include both bank-centric networks like POPmoney® as well as direct-to-consumer P2P networks such as PayPal™, Obopay™ or MasterCard's Moneysend™. However, there may be many more such networks coupled to the FMS 202 through the network 220.

In embodiments as described in more detail below, member FIs include a POPmoney® tab on their web sites for allowing their customers to make and request payments conveniently as in the course of any other online banking business. As further described, the PoPNet® internetworking hub 204 service system also presents a user interface directly to users so that payments can be made and requested directly with the financial management system 201 rather than through an FT web site.

Token databases 208 store various information regarding different network entities, different customers, or POPmoney® users, security information, etc. Tokens received from various nodes are stored in database 208. Tokens both identify the user, provide user data, and associate the user data with the node. The payment hub uses the token data to act as the intermediary of the transaction between two nodes on behalf of a user.

The financial management system 201 communicates with multiple third-party information providers (not shown) for the purpose of obtaining information related to security and risk management, such as credit reporting agencies, government databases, etc.

Users or customers communicate through network 220 with FIs 212 and FIs 214 as applicable, as well as with the financial management system 201. Users can communicate using a personal computer (PC) or other, similar system 218, or using a network-capable phone or other PDA 216. As further explained below, users can receive payments using the payment service whether or not they are members of the network. The system includes multiple payment networks 221. As further described below, an aspect of the invention as claimed is a common web site 215. Common web site 215, in this example, is hosted by POPmoney®. Users who are not members of the POPmoney® direct network, and also are not members or customers of a network FI, can still complete funds transfer transactions by logging onto the common site after being referred there in the course of a transaction. In an embodiment, users can save the financial transaction data on user applications 219, such as for example, Quickbooks™.

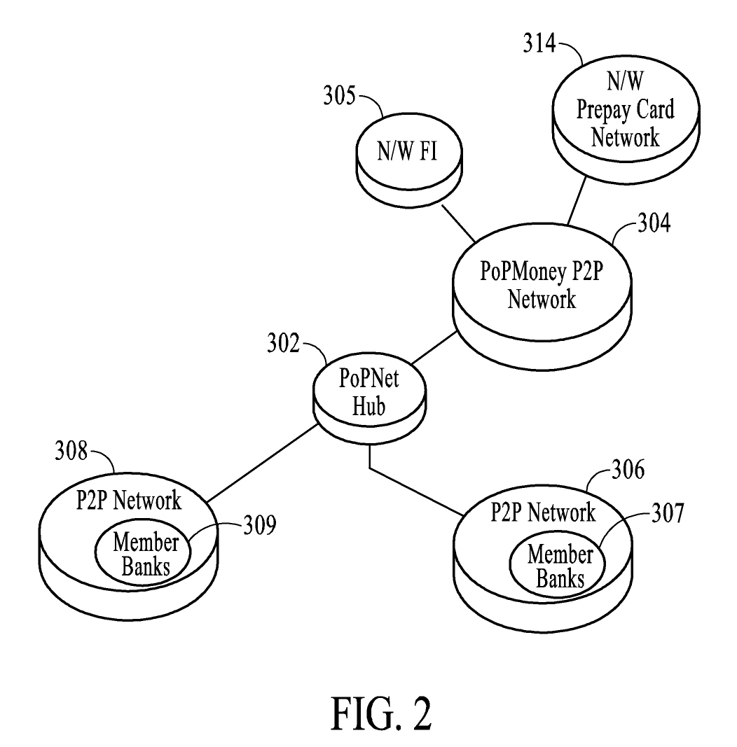

FIG. 2 is a diagram illustrating the interworking of various nodes by a payment hub 302. Payment hub 302 is illustrated here as a PopNet payment hub but embodiments are not so limited. Payment hub 302 is coupled to Popmoney P2P network 304. Network FIs 305 are coupled to the P2P network 304. As used herein, “network FI” includes other entities that might not be FIs as previously described. “Network” FIs are FIs that are members of the PopMoney P2P network 304. Network prepaid card networks 314 are similarly members of the PopMoney P2P network 304.

A node can be any of the entities previously mentioned, but is not limited to those. This diagram shows one example of a set of nodes that include independent P2P network 306 and independent P2P network 308. Each of networks 306 and 308 are “independent” in that they facilitate payment on behalf of consumers using their own relationships with respective member banks 309 and 307. One example of an independent P2P network.

Examples of transaction that are performed by the PoPNet™ hub include bank to bank transfers in which both banks are network banks. In this case, the sender of an invoice uses his own bank web site to request the transfer through the hub 302. The payee receives an email that appears to come from his own bank, but it is facilitated by the hub 302. The payee can pay from the bank web site from an existing. account.

Another type of transaction involves a user at a network bank sending an invoice to a payee who is not with a network bank. The payee then receives in an emailn phone message or text message that comes from the PoPNet hub 302 inviting the payee to log onto the PoPMoney site to view the invoice, become a member, and pay.

Another situation involves two non-FI entities. For example, the sender of the invoice may be a Facebook member, a merchant, etc.

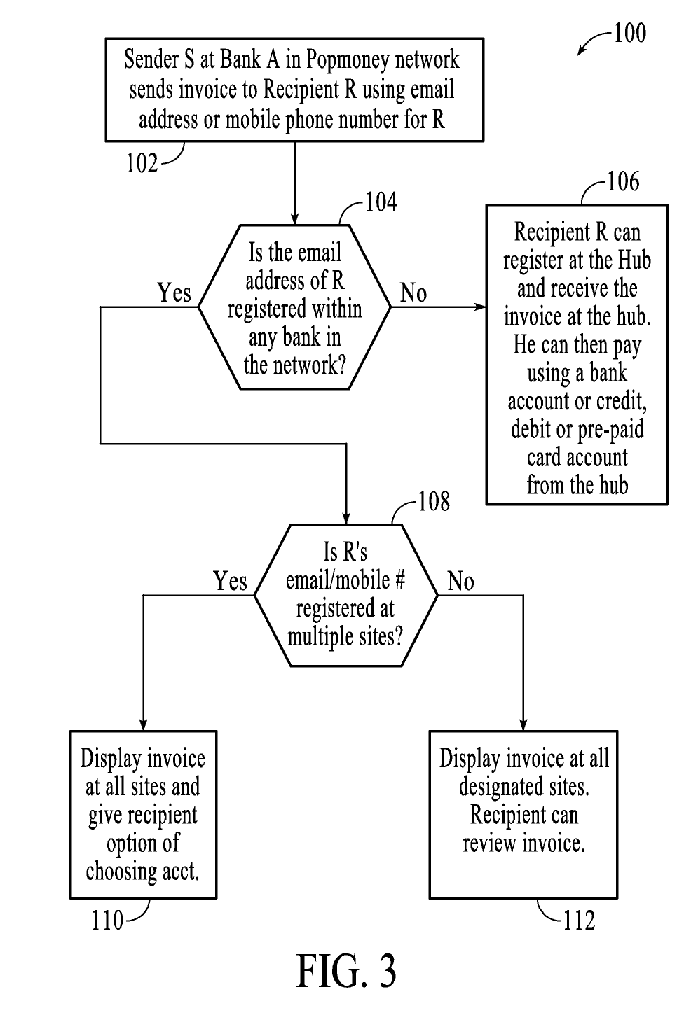

FIG. 3 is a flow diagram illustrating a process or payment method 100 according to an embodiment. A sender S may be small business or retail consumer at Bank A. Bank A is an example of a network node. That is, Bank A is in the Popmoney™ network). As shown at 102, sender S can send an invoice with the details of the requested payment to another small business or consumer. The format of the invoice can be customized as required by Bank A. The invoice can be sent using the email address or mobile phone of the recipient and can be originated from an online or from a mobile portal of the network bank. In addition, the invoice can also be sent from an independent portal or hub such as www.popmoney.com™, which is envisioned as the stand-alone site associated with the payment network 201. The invoice could also be originated from an independent portal, such as for example, and fed into the inter-bank network using the internetworking processes previously disclosed. The invoice contains details about the requested payment. Business invoices are typically more complex, with details of SKUs, pricing and payment terms. However, all types of business and personal invoices are supported.

It is determined at 104 whether the email address of the recipient R is registered at any network bank or financial institution (including any participating banks or affiliated parties such as independent portals with whom the network 201 inter-networked). In the first instance when sender S sends the invoice to a recipient R who is not registered at any network bank, the system sends an email or mobile communication (e.g. SMS message) to the intended recipient R about the invoice, as shown at 106. This communication could be just a notification that an invoice has been received or send the actual invoice to the recipient R. The recipient R has two options. If the recipient banks at another bank (Bank B) that subscribes to the Popmoney™ invoicing service, then he or she can log on to the online or mobile banking service of his or her bank and authenticate their email address or mobile phone number. If their bank does not belong to the network, they can register at the network hub www.Popmoney.com™ and register there with the same result. As soon as the authentication is completed, the invoice appears and can be accessed by the recipient.

If the invoice is sent to a recipient who is already registered at a network bank or an affiliated portal, then the invoice is directly and immediately routed to their destination as shown at 108 and 112. The recipient could be registered at multiple sites—either multiple participating banks and/or independent portals, as shown at 108 and 110. If the recipient is registered at Banks B and C and at an independent portal, then the invoice will be routed to all three destination points. The recipient has the choice of reviewing and making payment against that invoice in any one of the three places. He or she may choose to make partial payments from multiple receiving points.

As soon as the recipient finishes the registration process, the emailed invoice will appear within their online or mobile banking site. The recipient can review the invoice and conduct an email communication with the sender for questions or clarifications. The whole string of email communications is stored, and is accessible by the parties as needed—thus providing a complete transaction history and documentation. The recipient can pay for the invoice—in full or part—by using one of the pre-populated accounts at their bank. They can also use an external account such as a credit card or debit card to pay for the invoice. Once the payment transaction is submitted, the network 201 debits the source account and transfers funds directly to the bank account of the invoice sender.

Although the method and service described is oriented towards being used within a bank site, the payment can be made by the recipient of the invoice from a bank account or from a debit, credit or pre-paid card. By the same token, the originator or sender of the invoice can direct the payment to go to a default bank account or to a stored value card, or debit or credit card. The system effects the transfer of funds from the payor to the payee in a risk managed way.

If the recipient does not bank at a bank which subscribes to the Popmoney™ service, he or she has the choice of logging on to the hub (see 106), which is an independent site referred to in this example as www.popmoney.com™. The recipient can register at this site with the email or mobile phone that has been used by the sender to send the invoice. As soon as they complete the registration, the invoice appears on the hub and the recipient of the invoice can pay the full or partial amount by using their bank account at any bank. They can also use their credit or debit card or pre-paid account to pay for the invoice.

In both of the above cases, once the recipient has completed the initial registration process (that is, the recipient has registered with their email or mobile phone number) then all subsequent invoices to that address will automatically be directed to their bank. The recipient can then simply browse their bank site to see all the invoices that have been received by them. Like the initial transaction, they can pay for subsequent invoices by debiting their bank account. The system also envisions situations in which the user can designate that all invoices be automatically paid in full or part from the designated bank account. They recipient can select automatic payments from invoices from specified invoice senders.

In all cases, the system provides email and mobile alerts as needed to both sender and recipient about various stages of the transaction.

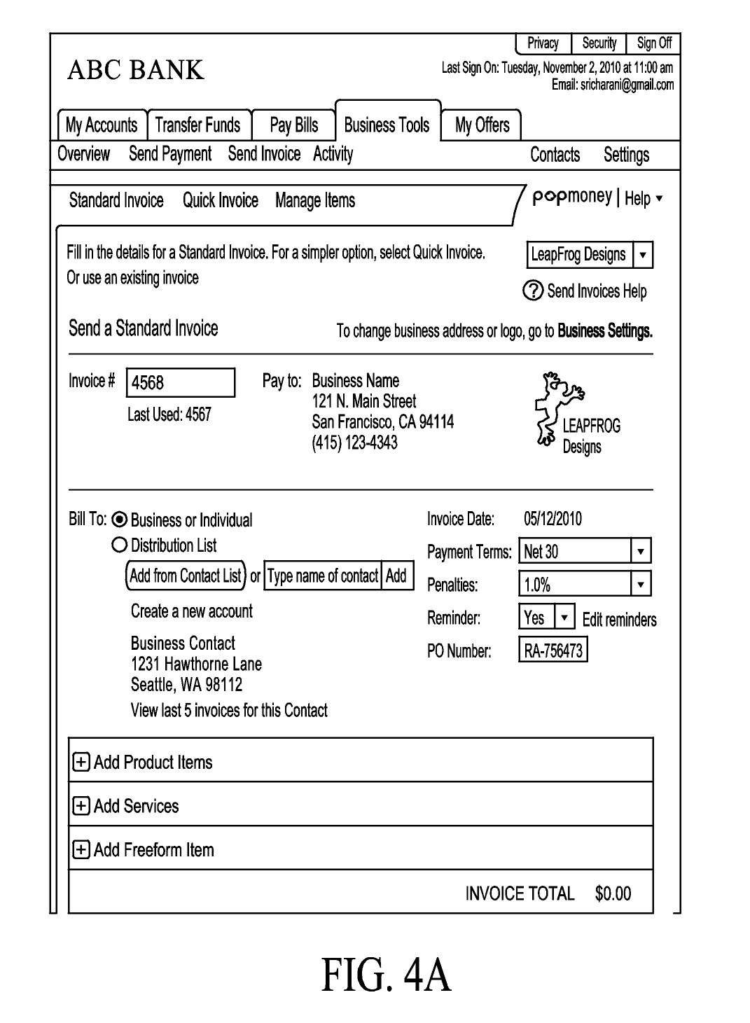

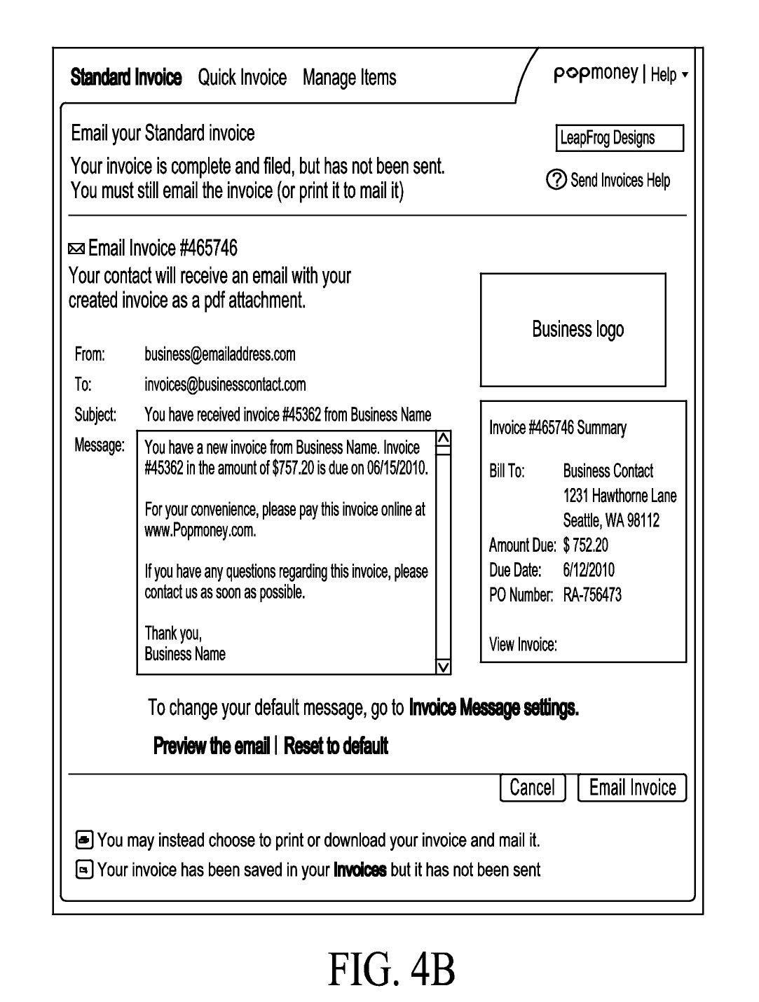

FIGS. 4A and 4B show screen shots of a user sending an invoice within online banking. FIG. 4A shows the screen the user sees within the bank site when the bank is a PopMoney member. FIG. 4B shows the screen the invoice that is generated.

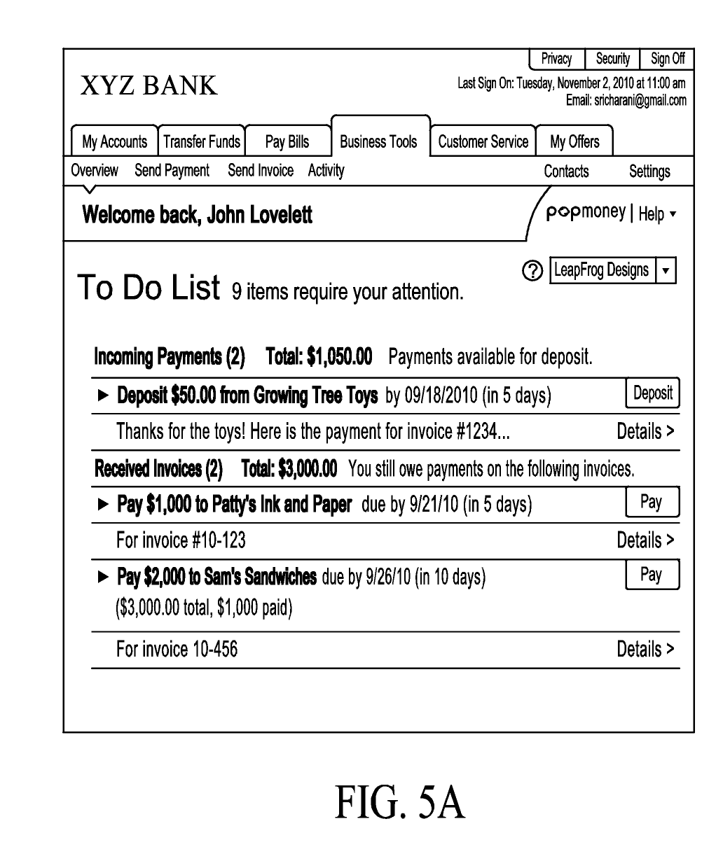

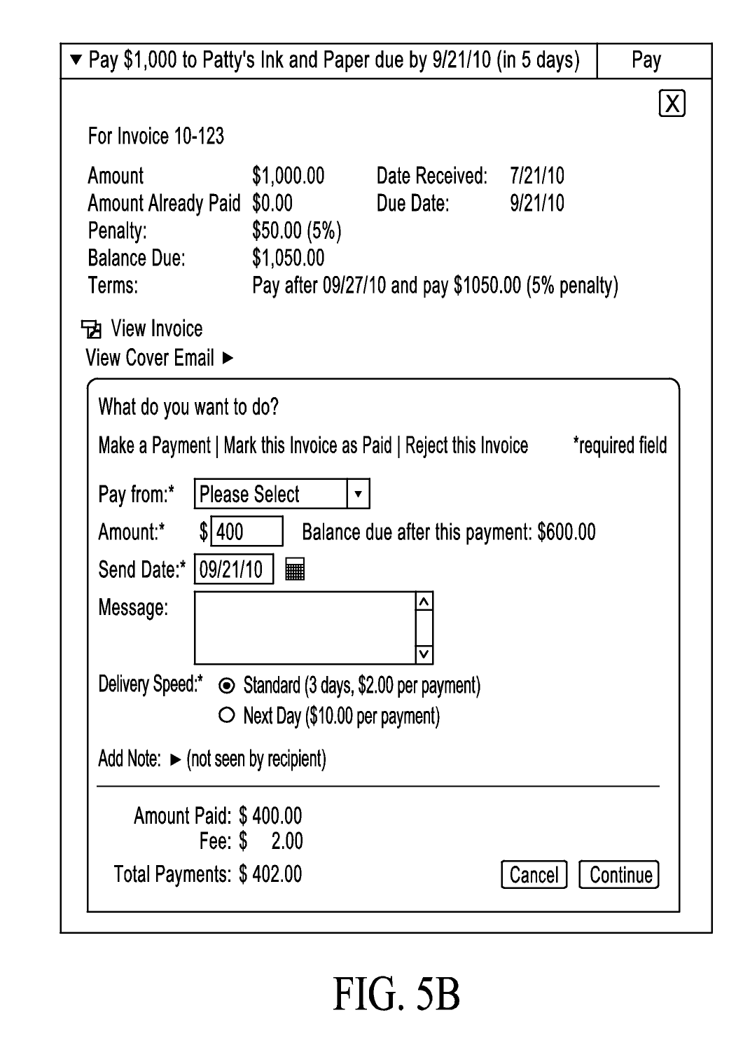

FIGS. 5A and 5B show screen shots of a user paying an invoice within the PopMoney hub. FIG. 5A shows the screen the user sees within the bank site when the bank is a PopMoney member. This screen includes pending activities. FIG. 5B shows the screen that is generated when the user chooses an invoice to pay. Because the bank is a network bank the account information is pre-populated.

Bank ABC and XYZ in FIGS. 4 and 5 may be the same or different banks.

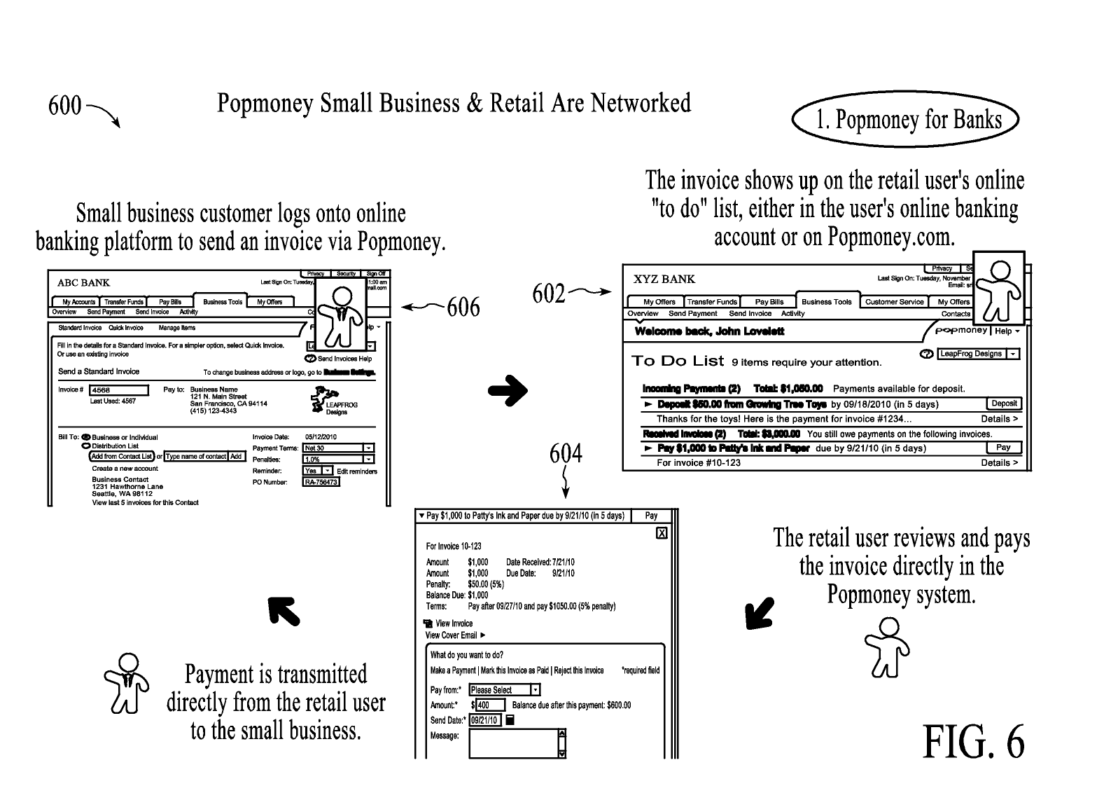

FIG. 6 is a diagram illustrating the manner in which small business and retail are internetworked.

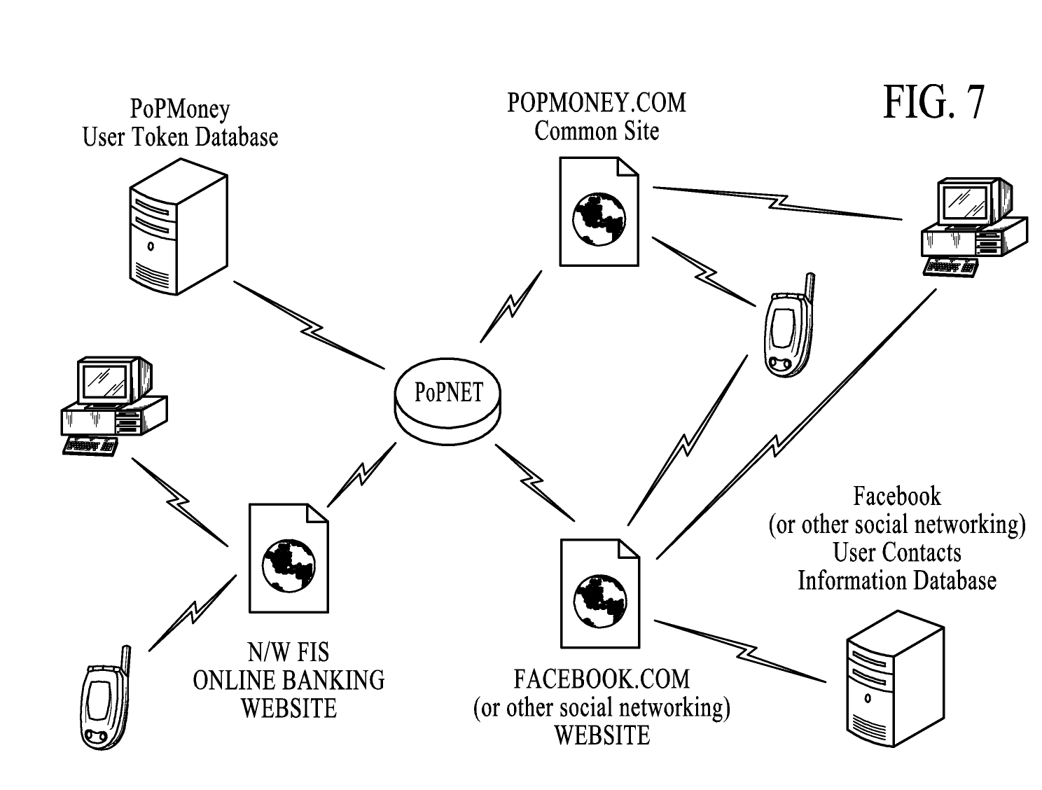

FIG. 7 is a diagram illustrating how PoPnet couples various entities as previously described and also couples social networking sites a nodes.

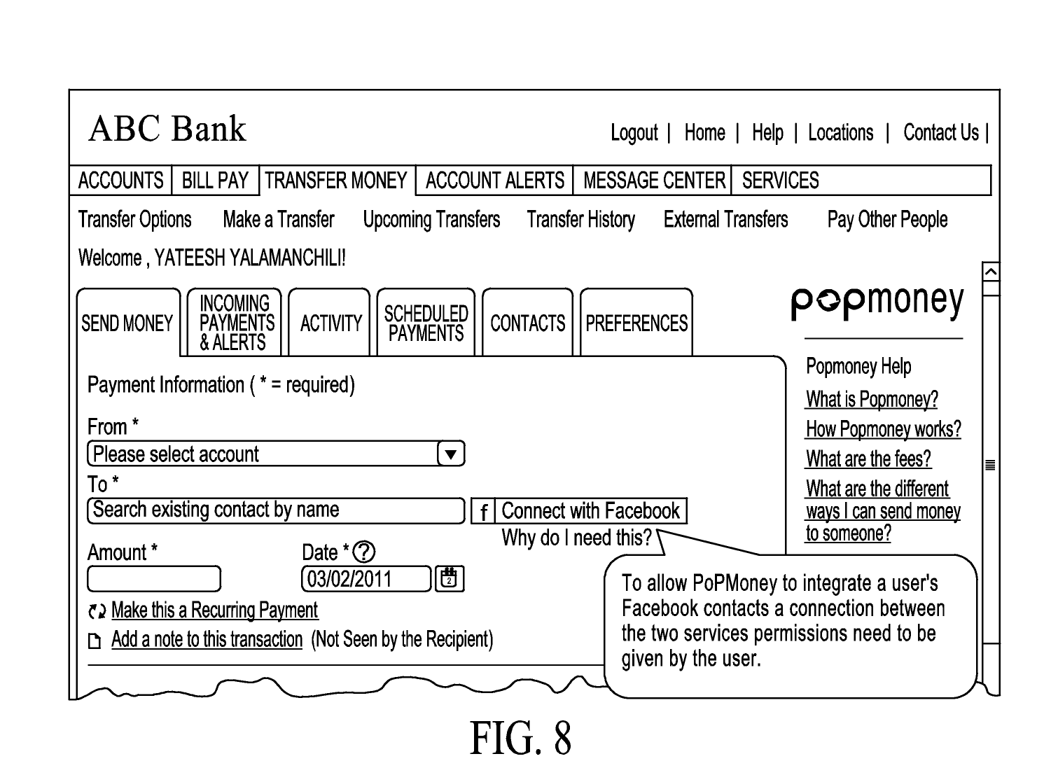

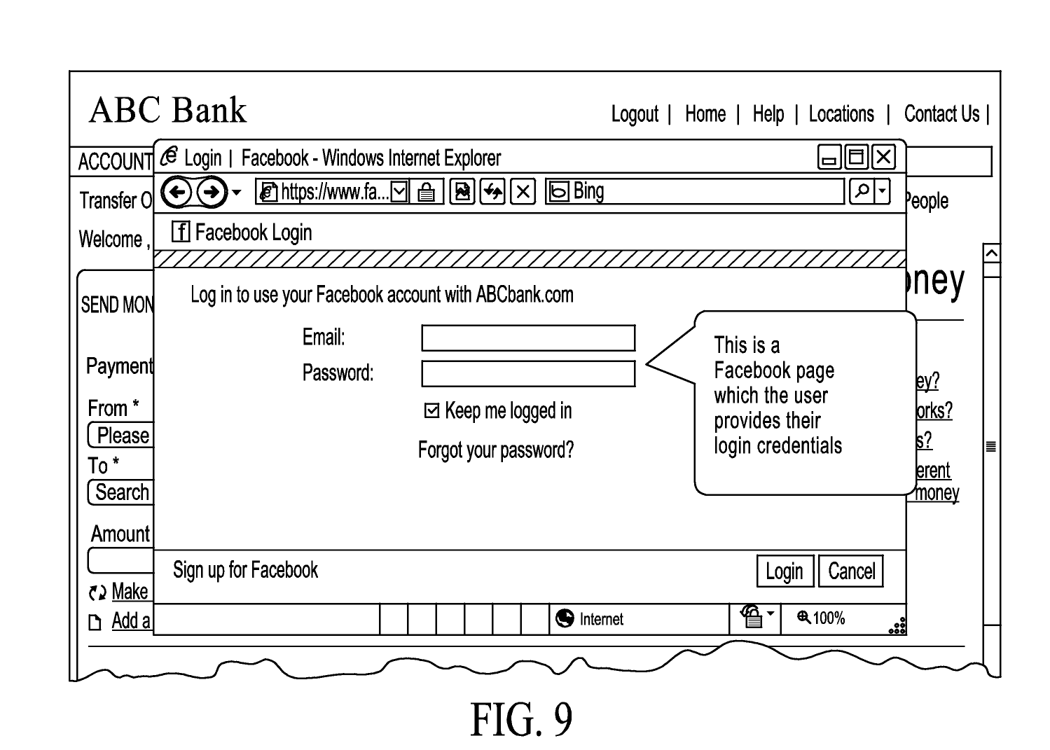

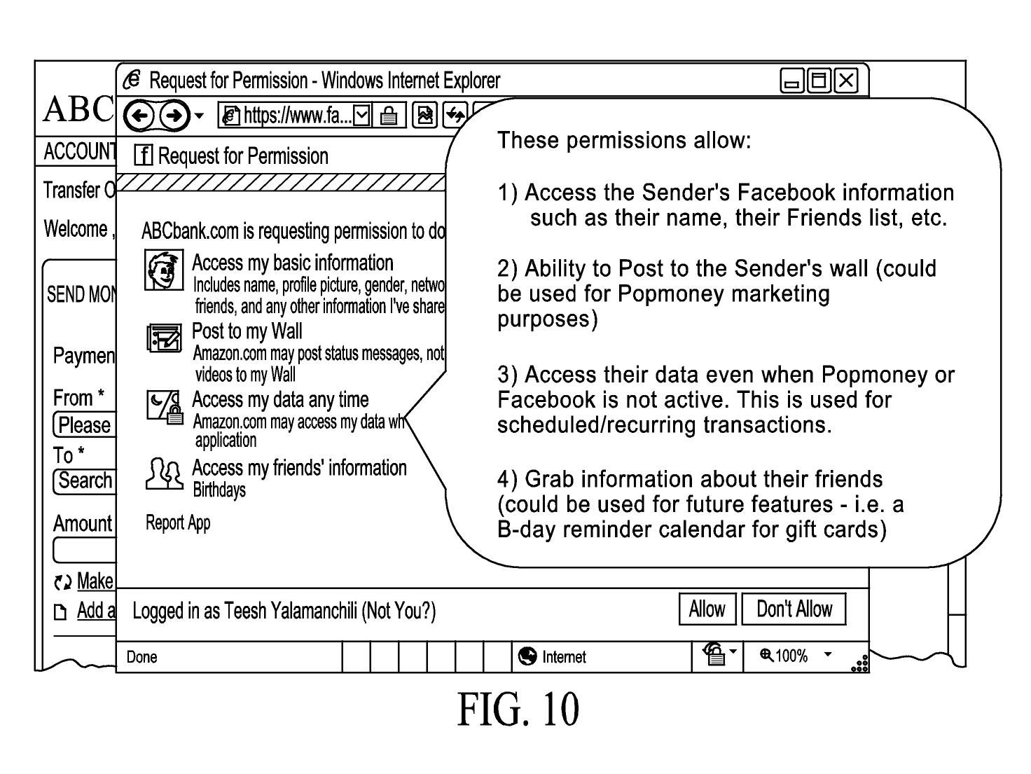

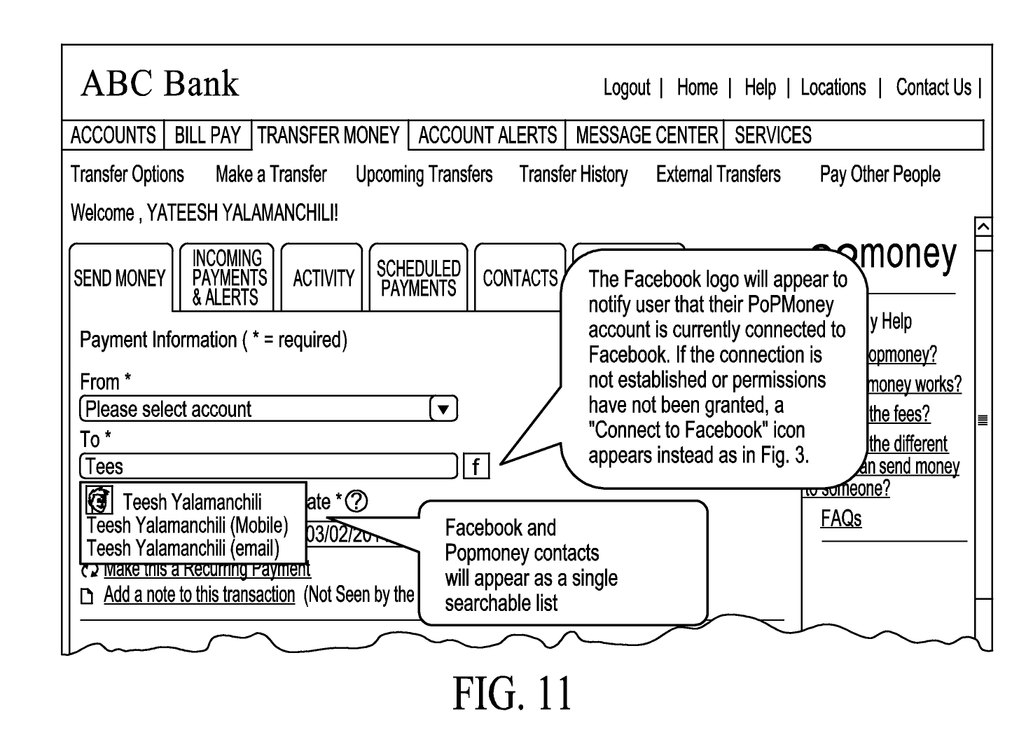

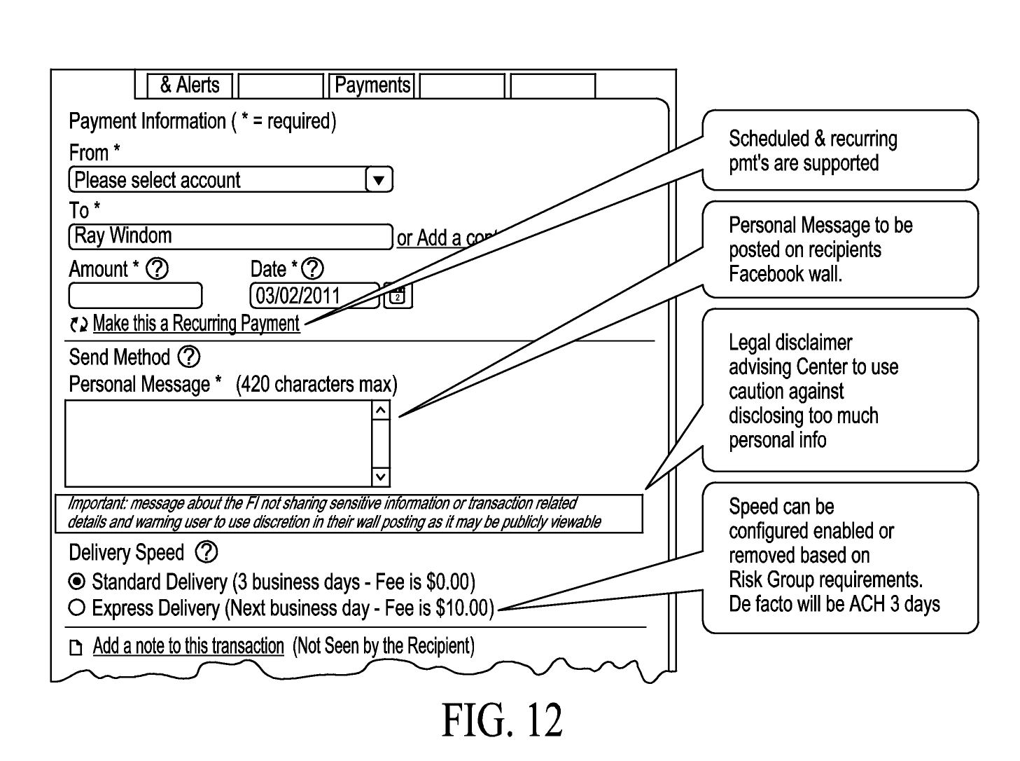

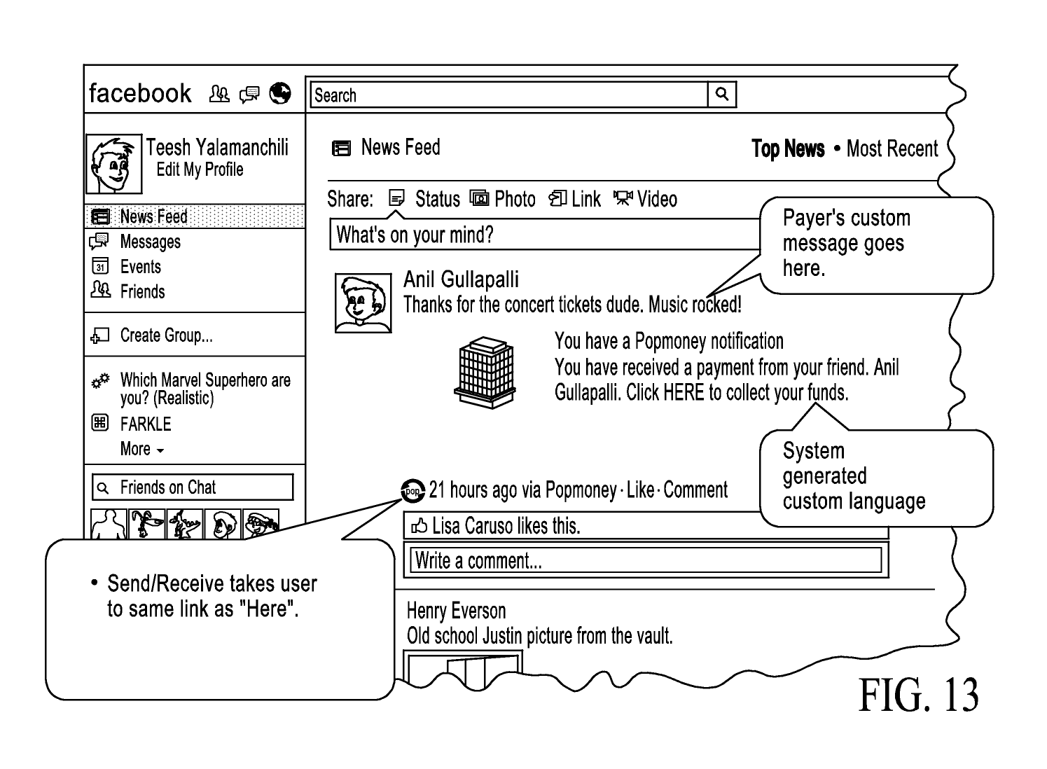

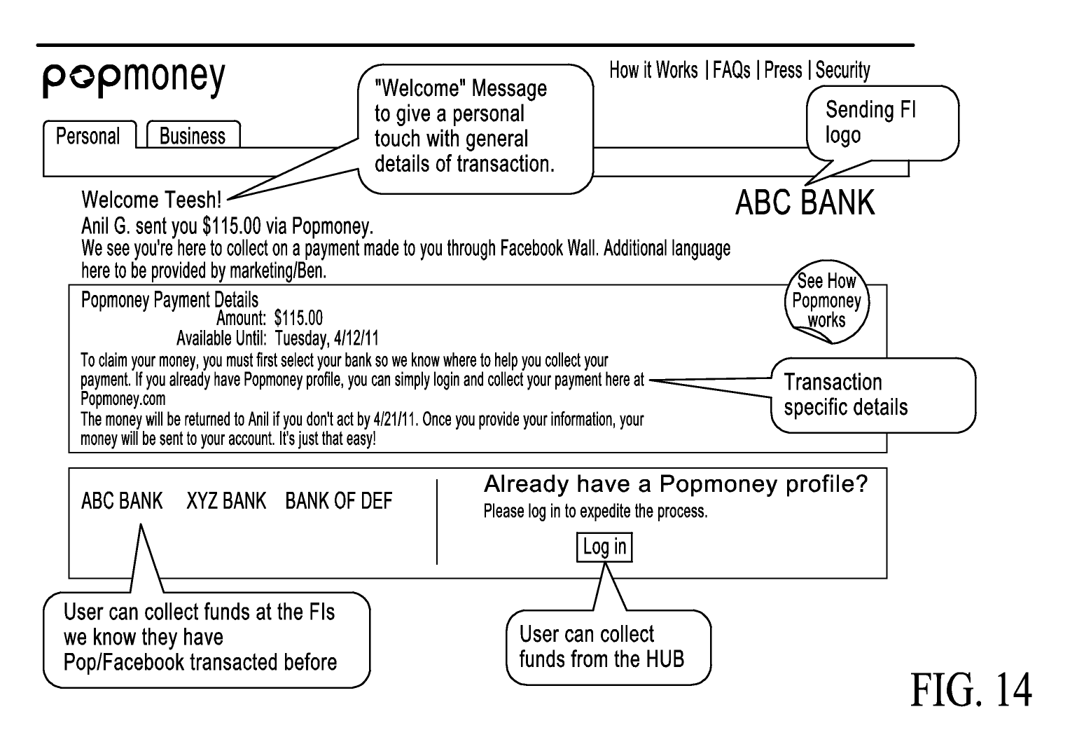

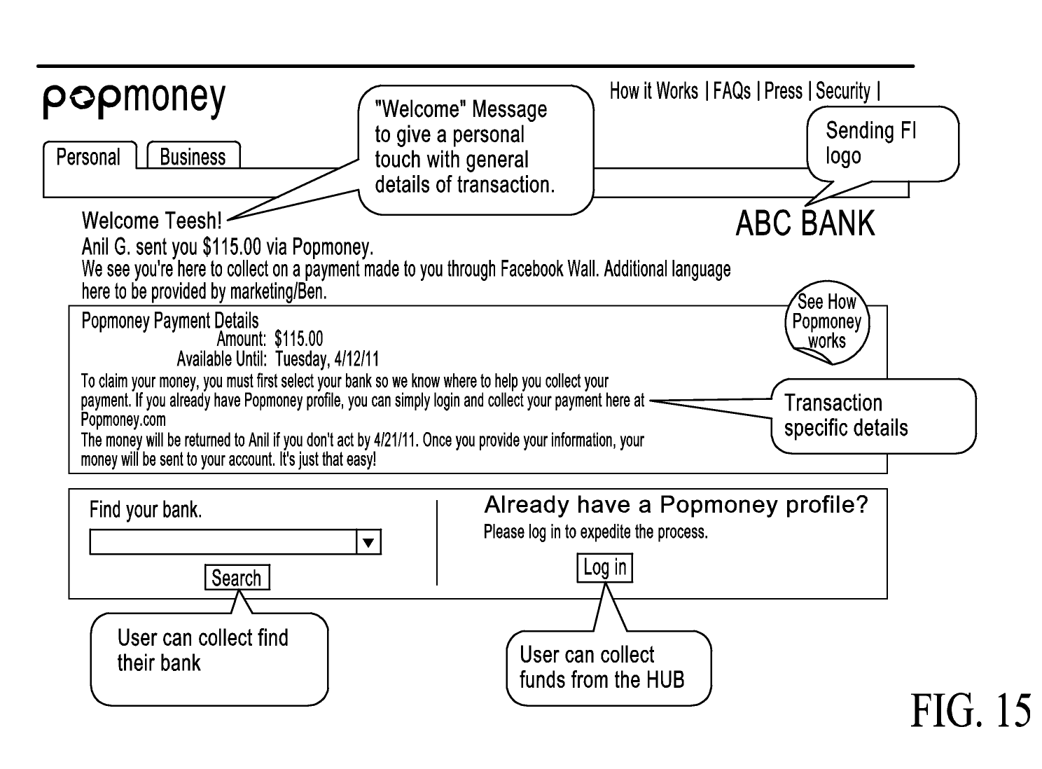

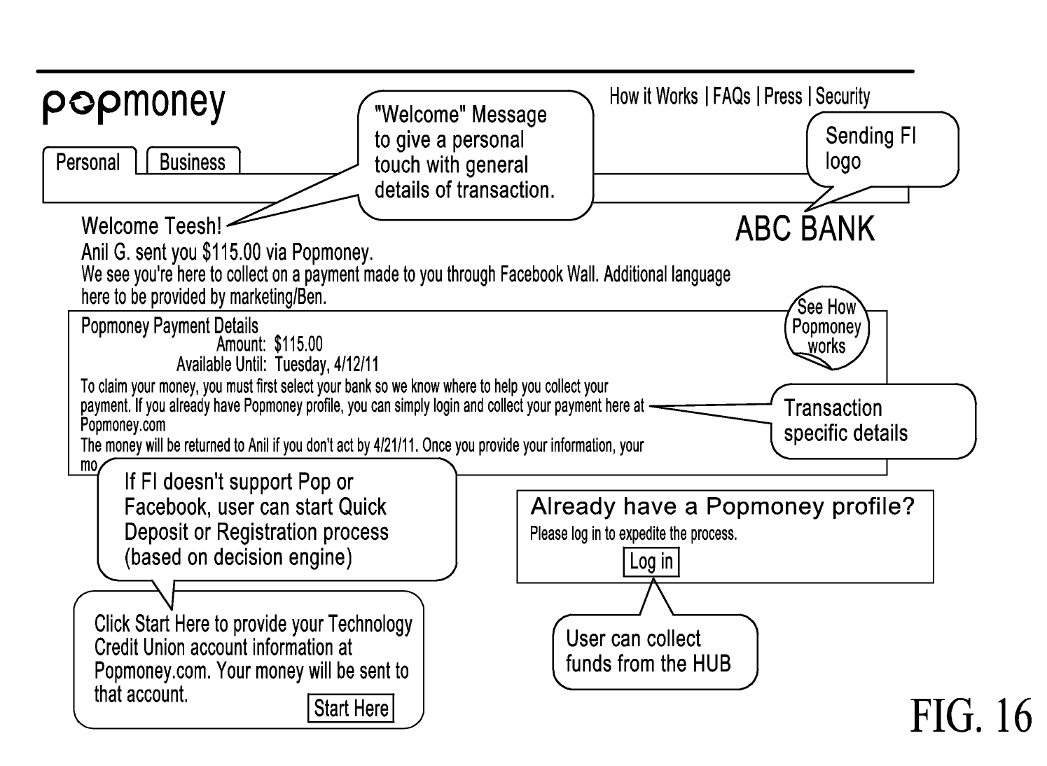

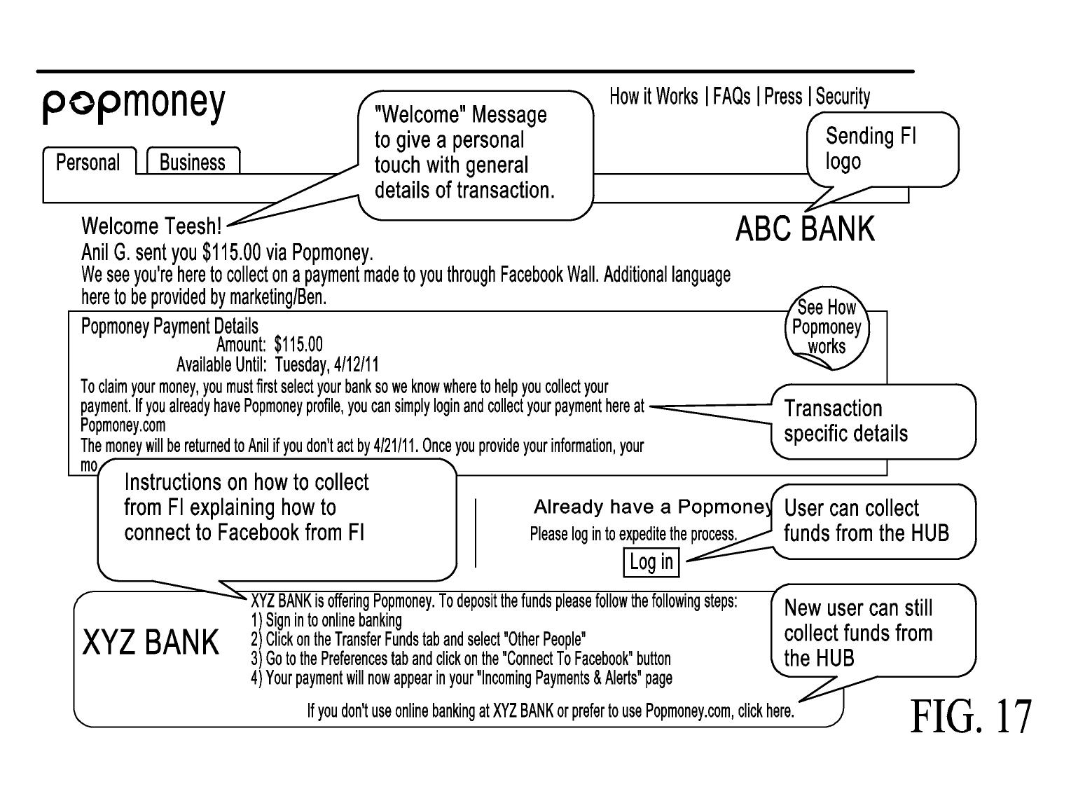

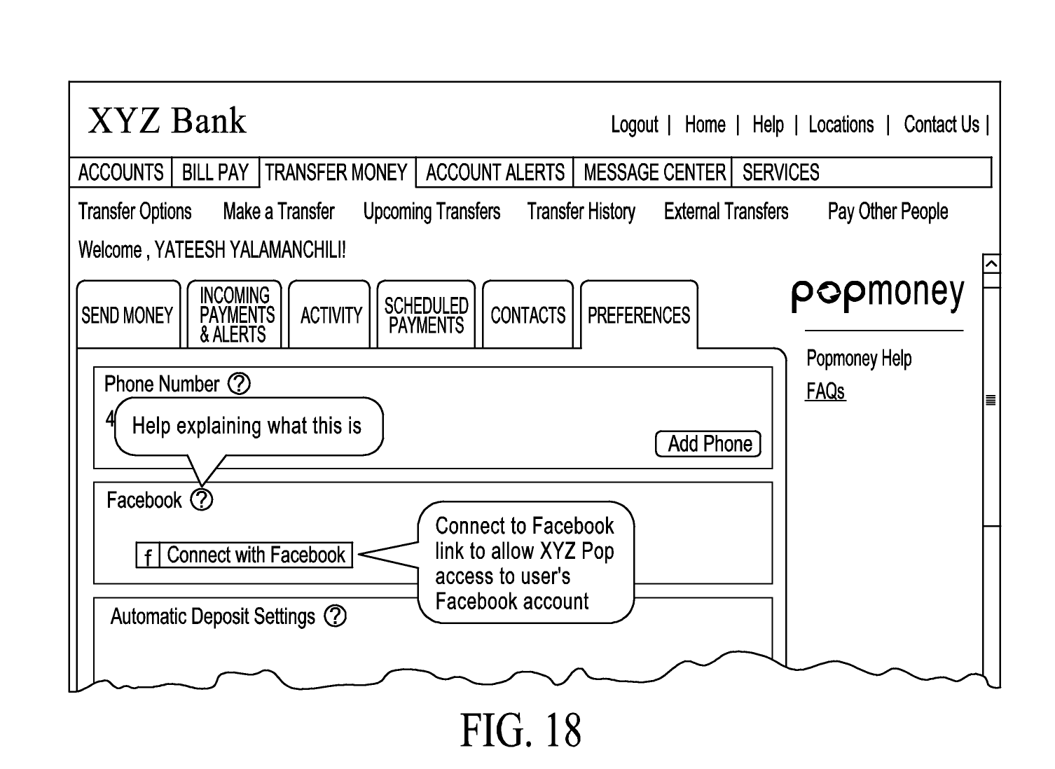

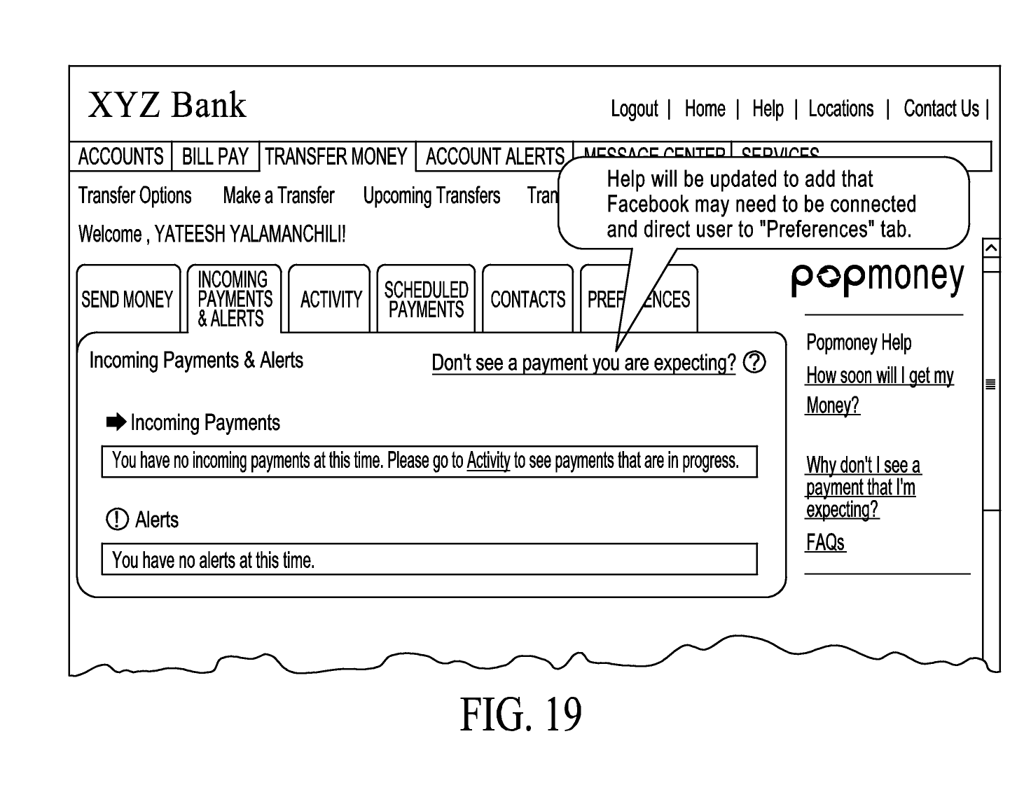

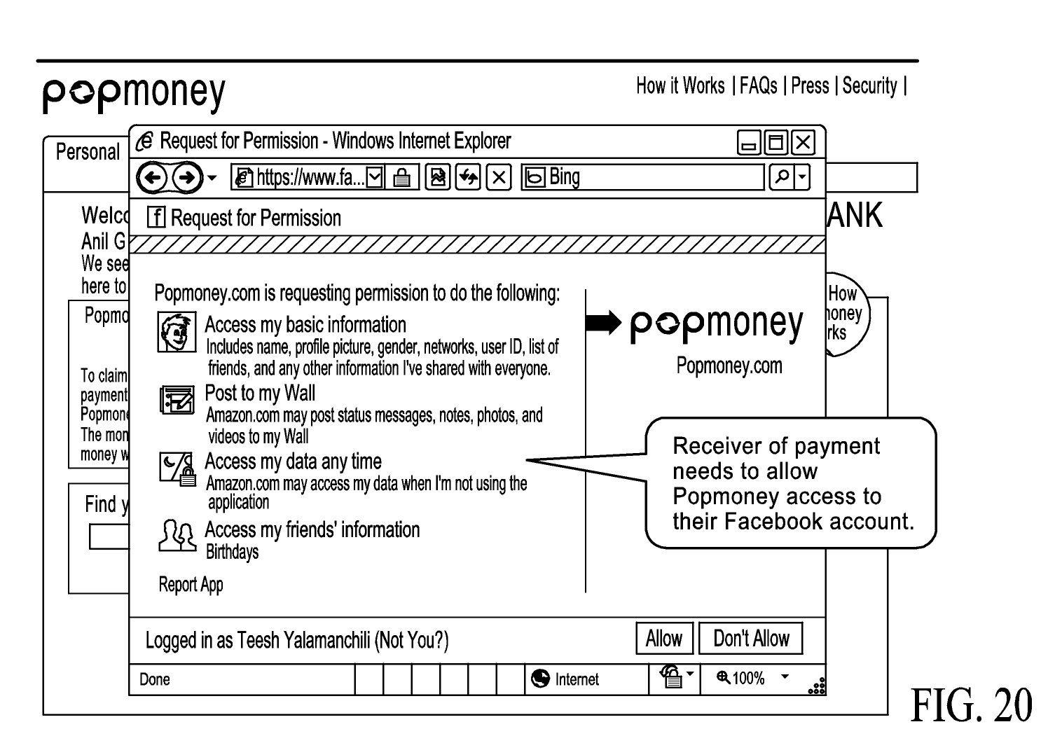

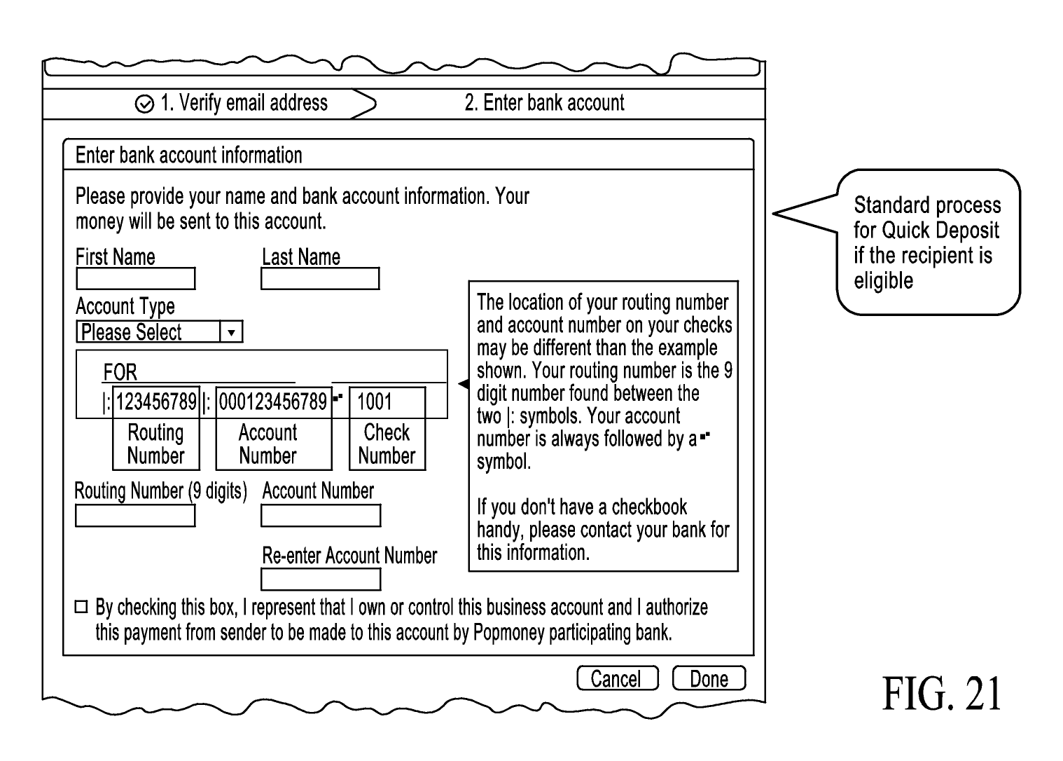

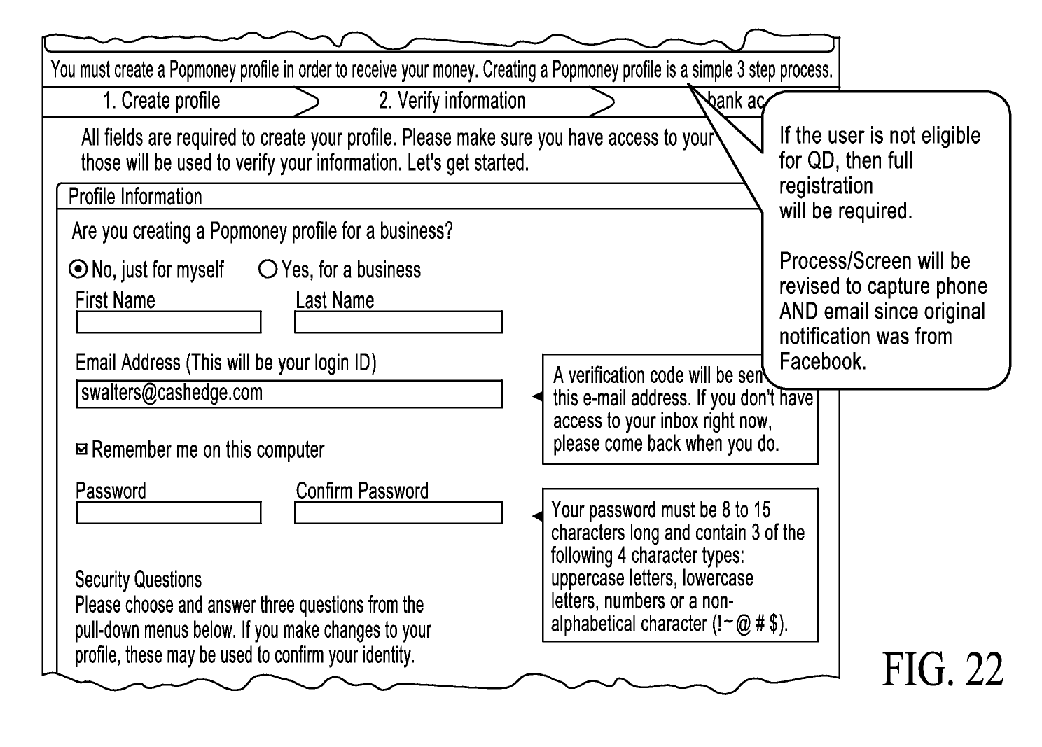

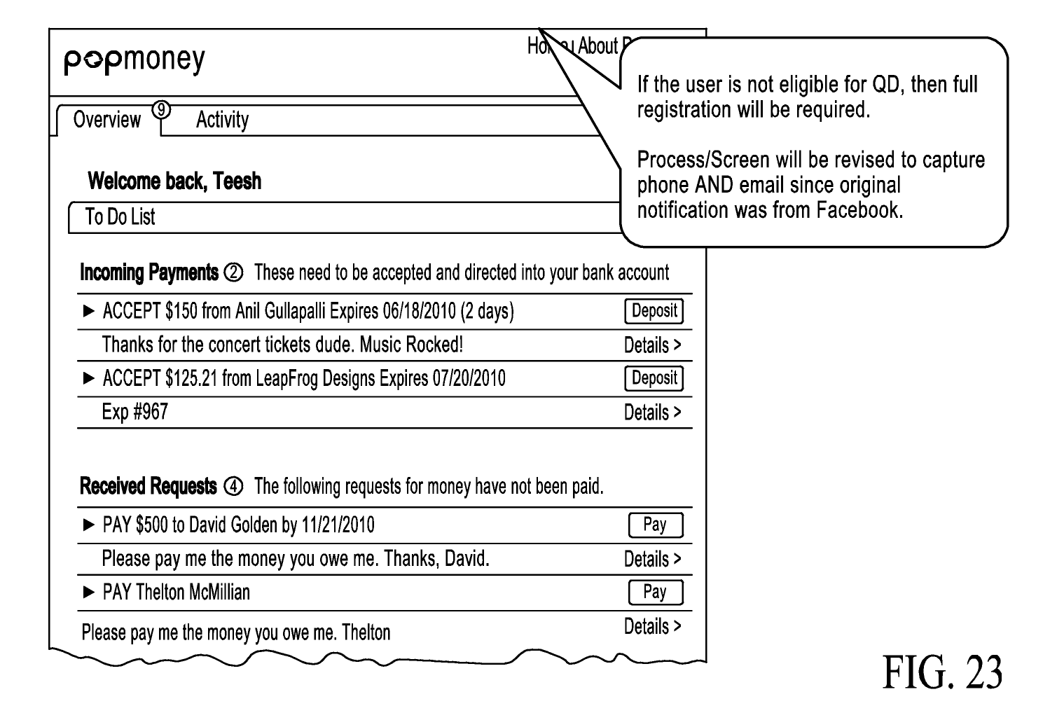

FIGS. 8-23 are screen shots illustrating how social networking sites are integrates as nodes in the network.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. As an example, although the anti-aliasing is generally described herein as an algorithm executed on hardware as a series of steps, the steps may be executed in an order other than the order described. In addition, the particular hardware or software components named, such as drivers, depth buffer, etc. are not meant to be exclusive or limiting.

The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Computer-readable media include any data storage object readable by a computer including various types of compact disc: (CD-ROM), write-once audio and data storage (CD-R), rewritable media (CD-RW), DVD (Digital Versatile Disc” or “Digital Video Disc), as well as any type of known computer memory device. Such computer readable media may store instructions that are to be executed by a computing device (e.g., personal computer, personal digital assistant, PVR, mobile device or the like) or may be instructions (such as, for example, various hardware description languages) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. A payment method comprising:
a payment network hub receiving an invoice from a sender, wherein the invoice includes an identification of a recipient;
the payment network hub determining whether the recipient is registered at a financial institution that is in the payment network; and
if the recipient is not registered at a financial institution that is in the payment network, communicating to the recipient that the invoice is available.

2. The method of claim 1, wherein the identification is an email address.

2a. The method of claim 1, wherein the identification is a mobile phone number.

3. The method of claim 1, wherein communicating further comprises sending the recipient and email inviting the recipient to register at the payment network hub and receive the invoice.

4. The method of claim 3, further comprising paying the invoice on behalf on the recipient.

4a. The method of claim 3, wherein paying the invoice further comprises:
executing an international financial transaction;
performing foreign exchange conversion; and
collecting fees associated with the international financial transaction.

5. The method of claim 4, wherein paying the invoice comprises using one or more of: a recipient bank account; a recipient credit card; a recipient debit card; and a recipient pre-paid card.

6. The method of claim 1, further comprising if the recipient is registered at a financial institution that is in the payment network.

6a. The method of claim 6, wherein if the recipient is registered at a financial institution that is in the payment network, the method further comprises determining whether the recipient is registered at multiple financial institution that are in the payment network.

7. The method of claim 6a, further comprising:
if the recipient is registered at multiple sites, displaying the invoice at each site; and
receiving payment instructions from the recipient.

8. The method of claim 7, wherein payment instructions comprise instructions to make the payment from more than one account.

9. The method of claim 7, further comprising:
in response to the instruction, executing an international financial transaction;
performing foreign exchange conversion; and
collecting fees associated with the international financial transaction.

10. The method of claim 1, wherein the payment network hub receiving an invoice from a sender comprises the sender communicating with the hub using a software application downloaded to a mobile device, wherein the mobile device comprises a smartphone and a personal computer.

11. The method of claim 1, wherein the sender comprises a business entity.

12. The method of claim 1, wherein the sender comprises an individual.

13. The method of claim 1, wherein the sender comprises an independent payment portal.

14. An inter-bank email and invoicing system, comprising:
an inter-bank email and invoicing network coupled to the internet, the network comprising:
a plurality of databases configurable to store data comprising financial data related to multiple financial institutions, data related to multiple users wherein users include account holders at financial institution, data related to members of the network, and data related to independent payment portals that are not members of the network;
a plurality of servers configurable to communicate via the Internet and to process data within the system; and
an internetworked payment hub configurable to,
receive an invoice from a sender, wherein the invoice includes an identification of a recipient;
the payment hub determining whether the recipient is registered at a financial institution that is a member of the network; and
if the recipient is not registered at a financial institution that a member of the network, communicating to the recipient that the invoice is available
